(19) United States
(12) Patent Application Publication
(10) Pub. No.: US 2016/0380658 A1
(43) Pub. Date: Dec. 29, 2016

(54) RECEIVER CIRCUIT AND ASSOCIATED METHOD CAPABLE OF CORRECTING ESTIMATION OF SIGNAL-NOISE CHARACTERISTIC VALUE

(71) Applicant: MStar Semiconductor, Inc., Hsinchu Hsien (TW)

(72) Inventors: Yu-Che Su, Zhubei City (TW); Tai-Lai Tung, Zhubei City (TW)

(21) Appl. No.: 14/847,084

(22) Filed: Sep. 8, 2015

(30) Foreign Application Priority Data
Jun. 26, 2015 (TW) 104120721

(51) Int. Cl. H04B 1/10; H04B 1/12

(52) U.S. Cl. CPC H04B 1/1027; H04B 1/123

(57) ABSTRACT

A receiver circuit capable of correcting an estimation of a signal-noise characteristic value (e.g., SNR) is provided. The receiver circuit includes an equalizer, a slicer, an estimation circuit and a correction circuit. The equalizer provides an equalized signal according to a received signal. The slicer interprets digital information in the equalized signal and accordingly provides a sliced signal. The estimation circuit provides an initial signal-noise characteristic value according to a difference between the equalized signal and the sliced signal. The correction circuit provides a corresponding correction value according to the initial signal-noise characteristic value, and corrects the initial signal-noise characteristic value according to the corresponding correction value to generate a corrected signal-noise characteristic value.

This application claims the benefit of Taiwan application Serial No. 104120721, filed Jun. 26, 2015, the subject matter of which is incorporated herein by reference.

### BACKGROUND OF THE INVENTION

Field of the Invention

The invention relates in general to a receiver circuit and an associated method capable of correcting an estimation of a signal-noise characteristic value, and more particularly to a receiver circuit and an associated method capable of correcting an over-estimated signal-noise characteristic value caused by hard decision slicing.

Description of the Related Art

Wired and/or wireless network systems are an essential part of the modern information society. A wired and/or wireless system include(s) a transmitter end and a receiver end, which are connected by a channel in between. For example, this channel may be a wireless channel formed by an air medium/space, or a wired channel formed by network lines or power lines. The transmitter end encodes and modulates digital information into transmission signals. The transmission signals are transmitted to the channel, propagated to the receiver end, and then received, demodulated and decoded to the digital information by the receiver end.

Signals are inevitably affected by noises, e.g., additive white Gaussian noise (AWGN), when transmitted in a network system. Therefore, a relationship between signals and noises are a critical factor in the design, implementation, deployment and optimization of a network system. The relationship between signals and noises can be quantized into a signal-noise characteristic value, e.g., signal-to-noise ratio (SNR), for reflecting a ratio of signal power to noise power. Relative to the power of a transmission signal that carries information, an SNR value of the transmission signal is larger if the noise power is lower. Such transmission signal transmitted from a transmitter end to a receiver end is less likely interfered by noises, and can thus carry information from the transmitter end to the receiver end with a higher accuracy (a lower error rate).

In a modern network system, the receiver end estimates the SNR to allow the receiver end and/or the transmitter end to adaptively adjust signal transmission and/or reception operations according to the SNR. For example, in an advanced power line network system, when the SNR value the receiver end estimates is higher, the receiver end reckons that the current information transmission conditions are satisfactory, and feeds such information back to the transmitter end to prompt the transmitter end to increase the rate. Conversely, when the SNR value the receiver end estimates is lower, the receiver end reckons that the current information transmission conditions are unsatisfactory in a way that data transmission is liable to errors. Thus, the receiver end feeds such information back to the transmitter end to prompt the transmitter end to reduce the rate in order to obtain an optimal throughput.

However, for the receiver end, as noises are random in nature and may be mixed (superimposed) with signals that carry information, the receiver end is capable of obtaining only an estimated SNR, which may not truly reflect the real SNR. If the difference between the SNR estimated by the receiver end and the real SNR gets too large, the performance of the network system may be degraded when the network system adaptively adjusts signal transmission and/or reception operations according to the estimated SNR. For example, when the SNR estimated by the receiver end appears more optimistic and is higher than the real SNR, the transmitter end may be mislead to increase the information transmission rate. As such, although the amount of data transmission is higher, the error is also higher because the signals the receiver end receives are in fact already interfered by high noises. That is to say, the amount of information effectively transmitted is conversely decreased.

### SUMMARY OF THE INVENTION

It is an object of the present invention to provide a receiver circuit (e.g., 20 in FIG. 1) capable of correcting an estimation of a signal-noise characteristic value (e.g., a signal-to-noise ratio, SNR) and disposed in a receiver end of a network system. The receiver circuit includes an equalizer (e.g., 24), a slicer (e.g., 26), an estimation circuit (e.g., 28) and a correction circuit (e.g., 30). The equalizer provides an equalized signal (e.g., s2) according to a received signal (e.g., s1). The slicer is coupled to the equalizer, and interprets digital information in the equalized signal to provide a sliced signal (e.g., s3) according to the equalized signal. The estimation circuit is coupled to the equalizer and the slicer, and provides an initial signal-noise characteristic value (e.g., SNRi[k]) according to a difference between the equalized signal and the sliced signal. The correction circuit is coupled to the estimation circuit, and provides a corresponding correction value (e.g., r[k]) according to a value of the signal-noise characteristic value, and corrects the initial signal-noise characteristic value according to the corresponding correction value to generate a corrected signal-noise characteristic value (e.g., SNRc[k]).

The correction circuit may include a look-up table (LUT) circuit (e.g., 34) and a multiplier (e.g., 32). The LUT circuit stores a plurality of predetermined correction values (e.g., e[p, 1] to e[p, N] in FIG. 6), and provides the corresponding correction value according to the initial signal-noise characteristic value and the predetermined correction values. Each of the predetermined correction values corresponds to one of a plurality of predetermined signal-noise characteristic values (e.g., SNRt[1] to SNRt[N]). The multiplier is coupled to the LUT circuit and the estimation circuit, and multiplies the initial signal-noise characteristic value by the corresponding correction value to accordingly generate the corrected signal-noise characteristic value. In one embodiment, when the LUT circuit provides the corresponding correction value according to the initial signal-noise characteristic value and the predetermined correction values, the LUT circuit identifies a predetermined signal-noise characteristic value (e.g., SNRt[n]) that is closest to the initial signal-noise characteristic value from these predetermined signal-noise characteristic values, and utilizes the predetermined correction value (e.g., e[p, n]) associated with the identified predetermined signal-noise characteristic value as the corresponding correction value. With the predetermined signal-noise characteristic values arranged in an increasing order, changes of at least a partial number of the corresponding predetermined correction values display a first increasing/decreasing trend and then display a second increasing/decreasing trend. The first increasing/decreasing trend is opposite the second increasing/decreasing trend. For example, the first increasing/decreasing trend may be strictly decreasing (or monotonically decreasing), and the second increasing/decreasing trend may be strictly increasing (or monotonically increasing).

The correction circuit provides the corresponding correction value further according to a modulation setting of the received signal. In one embodiment, the received signal includes a second number (greater than or equal to 1, e.g., K) of carriers (e.g., s1[1] to s1[K]), and carries corresponding digital information on a carrier (e.g., s1[k]) according to a corresponding modulation setting (e.g., ms[k]). Further, the corresponding modulation setting of each of the carriers is selected from a first number (e.g., greater than or equal to 1, e.g., P) of predetermined modulation settings MS[1] to MS[P]. For example, the predetermined modulation settings MS[1] to MS[P] may be binary phase shift keying (BPSK), quadrature phase shift keying (QPSK), 8 quadrature amplitude modulation (8QAM), 16QAM, 64QAM, 256QAM, 1024QAM and 4096QAM.

The estimation circuit provides an initial signal-noise characteristic value SNRi[k] for each carrier s1[k]. The correction circuit provides a corresponding correction value r[k] for each carrier according to the initial signal-noise characteristic value SNRi[k] of the carrier and the corresponding modulation setting ms[k] of the carrier, and corrects the initial signal-noise characteristic value of the carrier according to the corresponding correction value of the carrier, to generate a corrected signal-noise characteristic value SNRc[k] for the carrier. In the correction circuit, the LUT circuit stores a plurality of predetermined correction values e[p, 1] to e[p, N] for the predetermined modulation settings MS[p] (p=1 to P in FIG. 6), and provides the corresponding correction value SNRc[k] for each carrier s1[k] according to the corresponding modulation setting ms[k] of the carrier, the initial signal-noise characteristic value SNRi[k] of the carrier, and the predetermined correction values e[1, 1] to e[P, 1] . . . e[1, N] to e[P, N] of the predetermined modulation settings MS[1] to MS[P]. Each of the predetermined correction values e[p, n] (for n=1 to N) of the predetermined modulation settings is associated with one SNRt[n] of the plurality of predetermined signal-noise characteristic values SNRt[1] to SNRt[N]. The multiplier multiples the initial signal-noise characteristic value of each carrier by the corresponding correction value of the carrier to accordingly generate the corrected signal-noise characteristic value for the carrier.

When the LUT circuit provides the corresponding correction value for each carrier s1[k], a corresponding modulation setting ms[k] (e.g., MS[p1]) satisfying the carrier is identified from the predetermined modulation settings MS[1] to MS[P], and a predetermined signal-noise characteristic value (e.g., SNRt[n1]) that is closest to the initial signal-noise characteristic value SNRi[k] is identified from the predetermined signal-noise characteristic values SNRt[1] to SNRt[N], so as to utilize the predetermined correction value e[p1, n1] associated with the identified predetermined signal-noise characteristic value SNRt[n] from the predetermined correction values e[p1, 1] to e[p1, N] satisfying the predetermined modulation setting MS[p] as the corresponding correction value r[k] of the carrier. With the predetermined signal-noise characteristic values SNRt[1] to SNRt[N] arranged in an increasing order, changes of at least a partial number of the predetermined correction values display a first increasing/decreasing trend and then display a second increasing/decreasing trend, with the first increasing/decreasing trend and the second increasing/decreasing trend being opposite each other. With bit counts that the predetermined modulation settings MS[1] to MS[P] carry within one unit time arranged in an increasing order, changes of at least a partial number of the predetermined correction values e[1, n] to e[P, n] corresponding to the same predetermined signal-noise characteristic value SNRt[n] but corresponding to different predetermined modulation settings display a decreasing trend.

In one embodiment, the second number of carriers are a plurality of orthogonal frequency-division multiplexing (OFDM) carriers.

In one embodiment, the receiver circuit further includes a bit loading setting circuit (e.g., 38) coupled to the correction circuit. The bit loading setting circuit generates a feedback signal (e.g., s4 in FIG. 1) according to the corrected signal-noise characteristic value of each carrier to a transmitter circuit (e.g., 10) to update the corresponding modulation setting of the carrier. Thus, the transmitter circuit is allowed to carry subsequent digital information on the carriers according to the updated corresponding modulation setting of the carrier.

It is another object of the present invention to provide a method for correcting an estimation of a signal-noise characteristic value in a receiver circuit. The method includes: providing an equalized signal according to a received signal the receiver circuit receives, wherein the received signal includes a second number (K) of carriers s1[1] to s1[K], the carriers carry corresponding digital information according to a corresponding modulation setting ms[k], and the corresponding modulation setting ms[k] of the carriers is selected from a first number (P) of predetermined modulation settings MS[1] to MS[P]; performing a slicing step to provide a sliced signal according to the equalized signal; performing an estimating step to provide an initial signal-noise characteristic value SNRi[K] for each of the carriers according to a difference between the equalized signal and the sliced signal; and performing a correcting step to provide a corresponding correction value r[k] according to a value of the initial signal-noise characteristic value of the carrier, and correcting the initial signal-noise characteristic value according to the corresponding correction value of the carrier and the signal-noise characteristic value of the carrier to generate a corrected signal-noise characteristic value for the carrier.

The step of providing the corresponding correction value according to the initial signal-noise characteristic value further comprises: providing the corresponding correction value according to a modulation setting of the received signal, the initial signal-noise characteristic value and a plurality of predetermined correction values, wherein each of the predetermined correction values corresponds to one of a plurality of predetermined signal-noise characteristic values; and identifying a predetermined correction value corresponding to the predetermined signal-noise characteristic value that is closest to the initial signal-noise characteristic value from the predetermined correction values to provide the corresponding correction value.

For example, when providing the corresponding correction value for each of the carriers, a corresponding modulation setting ms[k] (e.g., MS[p1]) satisfying the carrier is identified from the predetermined modulation settings MS[1] to MS[P], and an initial signal-noise characteristic vale (e.g., SNRt[n1]) that is closest to the initial signal-noise characteristic value SNRi[k] is identified from the predetermined signal-noise characteristic values SNRt[1] to SNRt[N], so as to utilize the predetermined correction value e[p1, n1] associated with the identified predetermined signal-noise characteristic value SNRt[n] from the predetermined correction values e[p1, 1] to e[p1, N] satisfying the predetermined modulation setting MS[p] as the corresponding correction value r[k] of the carrier.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 shows a receiver circuit according to an embodiment of the present invention;

FIG. 2 shows constellation points on a scatter plot in a predetermined modulation setting;

FIG. 3 shows a decision interval division;

FIG. 4a and FIG. 4b shows a decision interval division with fixed borders and misestimation of signal-noise characteristic values;

FIG. 5 shows misestimation of signal-noise characteristic values of different modulation settings under a decision interval division with fixed borders;

FIG. 6 shows a table providing correction values according to an embodiment of the present invention;

FIG. 7 shows an application of the table in FIG. 6;

FIG. 8 shows uncorrected initial signal-noise characteristic values and corrected signal-noise characteristic values; and

FIG. 9 shows a process according to an embodiment of the present invention.

### DETAILED DESCRIPTION OF THE INVENTION

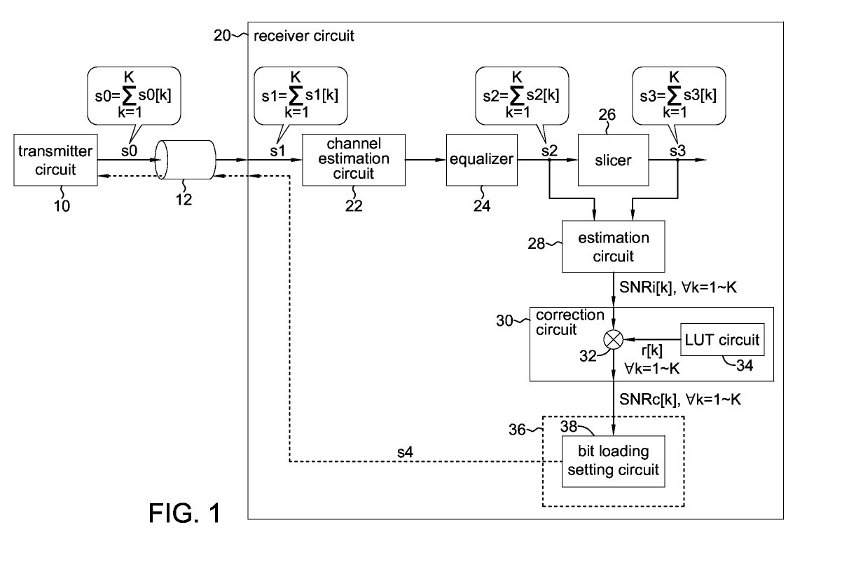

FIG. 1 shows a receiver circuit 20 according to an embodiment of the present invention. The receiver circuit 20 is adapted to receive a signal s0 transmitted from a transmitter circuit 10 via a channel 12. For example, the transmitter circuit 10 and the receiver circuit 20 may be respectively disposed at a transmitter end and a receiver end of a network system. The channel 12 may be a wired or wireless channel. For example, the channel 12 may be a power line transmitting alternating-current power. When the transmitter circuit 10 is to transmit digital information to the receiver circuit 20, the transmitter circuit 10 may encode and modulate the digital information into the signal s0, which is then transmitted to the receiver circuit 20 through the channel 12. Having been transmitted by the channel 12, the signal s0 is affected by noises to become a signal s1 (a received signal). The receiver circuit 20 may include a channel estimation circuit 22, an equalization circuit 24, a slicer 26, an estimation circuit 28 and an application circuit 36. To achieve the object of correcting the signal-noise characteristic value of the present invention, the receiver circuit 20 further includes a correction circuit 30.

In an example, the signal s0 may include K carriers s0[1] to S0[K]. Within one unit time, the transmitter circuit 10 may modulate and carry digital information of one symbol smb[k] (not shown) according to a modulation setting ms[k] (not shown) on a carrier s0[k]. The modulation setting ms[k] of the carrier s0]k] may be selected from P predetermined modulation settings MS[1] to MS[P]. Taking P=8 for example, predetermined modulation settings MS[1] to MS[8] may be orthogonal frequency-division multiplexing (OFDM) modulation methods including BPSK, QPSK, 8QAM, 16QAM, 64QAM, 256QAM, 1024QAM and 4096QAM. The modulation settings ms[k1] and ms[k2] of different carriers s0[k1] and s0[k2] may be the same or different. The modulation setting ms[k] of the same carrier s0[k] may also be constant, or may dynamically change. For example, to transmit a first symbol, the modulation setting ms[1] of the carrier s0[1] may be the predetermined modulation setting MS[1] (BPSK); to transmit another symbol, the modulation setting ms[1] of the carrier s0[1] may be the predetermined modulation setting MS[2] (QPSK).

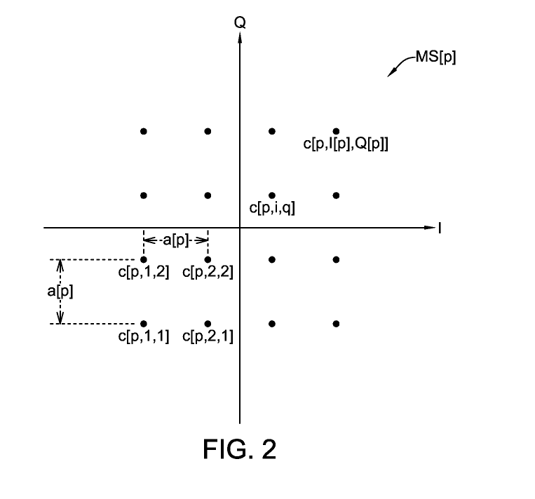

The predetermined modulation setting MS[p] may carry digital information according to M[p] constellation points. In continuation of FIG. 1, FIG. 2 shows M[p] constellation points c[p, i, q] (i=1 to I[p], and q=1 to Q[p]) of a predetermined modulation setting MS[p] in a scatter plot, where M[p]=I[p]*Q[p]. In FIG. 2, the horizontal axis represents an in-phase component of each constellation point c[p, i, q], and the vertical axis represents a quadrature-phase component of each constellation point c[p, q]. For example, assuming a predetermined modulation setting MS[4] is 16QAM, digital information can be carried according to M[4]=I[4]*Q[4]=4*4=1 constellation points c[4, 1, 1], c[4, 1, 2], c[4, 2, 1], c[4, 2, 2], c[4, i, q] to c[4, 4, 4]. Coordinates (AI[p, i, q], AQ[p, i, q]) (not shown) of each constellation point c[p, i, q] may equal to ((i−0.5*1[p]−0.5)*a[p], (q−0.5*Q[p]−0.5)*a[p]), where the item q[p] is a distance between two adjacent constellation points, as shown in FIG. 2 For example, assuming a predetermined modulation setting MP[4] is 16QAM, i=1 and q=1, the coordinates of the constellation point c[4, 1, 1] are ((1−0.5*4−0.5)*a[p], (1−0.5*4−0.5)*a[p])=(−1.5*a[p], −1.5*a[p]). Each constellation point c[p, i, q] may correspond to digital predetermined information (SMB[p, i, q]) (not shown) of a symbol. Taking a predetermined modulation setting MS[4] being 16QAM for example, the digital predetermined information SMB[4, i, q] corresponding to each constellation point c[4, i, q] may be a combination of log₂(16)=4 bits. In the signal s0, when the transmitter circuit 10 (in FIG. 1) is to adopt the predetermined modulation setting MS[p] as the modulation setting ms[k] for the carrier s0[k] to carry predetermined information SMB[p, i, q], the carrier s0[k] may be formed according to AI[p,i,q]*cos(2*π*f[k]*t)+AQ[p,i,q]*sin(2*π*f[k]*t) (not shown), where the item f[k] is the frequency of the carrier s0[k] and the item t is the time.

For example, assuming a predetermined modulation setting MS[p1] is QPSK, there are M[p1]=4 constellation points c[p1, 1, 1], c[p1, 2, 1], c[p1, 1, 2] and c[p1, 2, 2], which correspond to predetermined information SMB[p1, 1, 1], SMB[p1, 2, 1], SMB[p1, 1, 2] to SYM[p1, 2, 2] respectively being 00, 10, 01 and 11 in log₂(M[p1])=log₂(4)=2 bits. Due to power normalization, for different predetermined modulation settings MS[p1] and MS[p2], distances a[p1] and a[p2] between adjacent constellation points may be different. For example, when the predetermined modulation settings MS[1] to MS[P] are respectively BSPK, QPSK, 8QAM, 16QAM, 64QAM, 256QAM, 1024QAM and 4096QAM, distances a[1]>a[2]> . . . a[P].

Again referring to FIG. 1, after the transmission through the channel 12, the K carriers s0[1] to s0[k] in the signal s0 respectively form K carriers s1[1] to s1[k] in the signal s1. In the receiver circuit 20, the equalizer 24 is coupled to the channel 12, and performs equalization on the carriers s1[1] to s1[k] in the signal s1 to respectively form carriers s2[1] to s2[k] in a signal s2. The slicer 26, coupled to the equalizer 24, interprets the digital information carried in the carriers s2[1] to s2[k] in the signal s2 and accordingly provides carriers s3[1] to s3[k] in a signal s3 (a sliced signal). The estimation circuit 28, coupled to the equalizer 24 and the slicer 26, provides an initial signal-noise characteristic value for each carrier s1[k] according to a difference between the carrier s2[k] and the carrier s3[k].

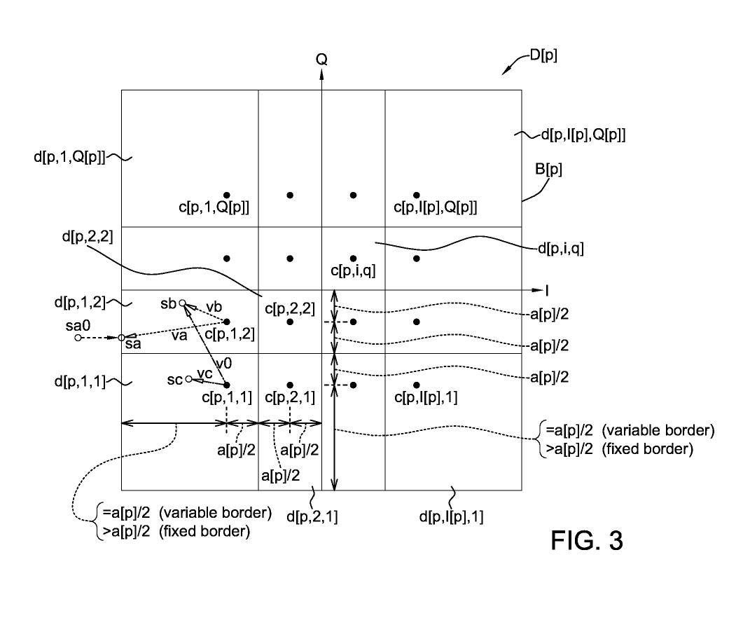

In continuation of FIG. 1 and FIG. 2, FIG. 3 shows operations of the equalizer 24 and the slicer 26 by a scatter plot. When predetermined information SMB[p, i, q] is modulated by the transmitter circuit 10 according to a predetermined modulation setting MS[p] to the carrier s0[k] in the signal s0 (in FIG. 1), and is transmitted through the channel 12 to become the carrier s1[k] in the signal s1 the receiver circuit 20 receives, due to factors such as noises, a corresponding point of the carrier s1[k] on the scatter plot does not overlap the constellation point c[p, i, q] corresponding to the carrier s0[k] on the scatter plot. For example, the constellation point corresponding to the carrier s0[1] is c[p, 1, 1], and the point corresponding to the carrier s1[1] may be sa0, sb or sc. The equalizer 24 performs equalization on the carrier s1[k] to converge the equalized carrier s2[k] to being within a border B[p]. For example, assuming that the point sa0 corresponding to the carrier s1[1] exceeds the border B[p], the point sa corresponding to the carrier s2[1] then falls on the border B[p]. For another example, assuming that point corresponding to the carrier s1[1] is within the border B[p], e.g., sb or sc, the point corresponding to the equalized carrier s2[1] still falls within the border B[p].

Next, the slicer 26 interprets the digital information according to a decision interval division D[p] associated with the predetermined modulation setting MS[p] the carrier s0[k] adopts. The decision interval division D[d] divides a plurality of decision intervals d[p, 1, 1] to d[p, I[p], Q[p]0 within the borders B[p], as shown in FIG. 3. Each of the decision intervals d[p, i, q] may cover the corresponding constellation point c[p, i, q], and is associated with M[p] sets of predetermined information SMB[p, 1, 1] to SMB[p, I[p], Q[p]] of the predetermined modulation settings MS[p]. In a decision interval division with variable borders, each of the decision interval divisions d[p, i, q] may be a square, which has the constellation point c[p, i, q] as the center and side lengths equal to the distance a[p] between adjacent constellation points. In a decision border division with fixed borders, the decision intervals d[p, 1, 1] to d[p, I[p], 1], d[p, 1, 1] to d[p, 1, Q[p]], d[p, 1, Q[p]] to d[p, I[p],Q[p]], and d[p, I[p], 1] to d[p, I[p], Q[p]] (i.e., the border decision interval) may be a rectangle, which has at least one side length greater than the distance a[p] between adjacent constellation points and does not regard the constellation point c[p, q] as the center. The decision interval outside the border decision interval may be a square, which regards the constellation point c[p, i, q] as the center and side lengths equal to the distance a[p] between the adjacent constellation points. By determining the decision interval in which the point corresponding to the carrier s2[k] falls on the scatter plot, the slicer 26 determines the constellation point c[p, i, q] corresponding to carrier s0[k] the transmitter circuit 10 transmits on the scatter plot to further interpret the digital information carried in the carrier s2[1]. For example, as shown in FIG. 3, assuming that the carrier s2[1] is located at the point s1, as the point sa falls in the decision interval d[p, 1, 2], the slicer 26 determines that the constellation point corresponding to the carrier s0[1] is c[p, 1, 2], and interprets the digital information carried in the carrier s1[1] as the predetermined information SMB[p, 1, 2]. Assuming that the carrier s2[1] is located at the point sb, as the point sb also falls in the decision interval d[p, 1, 2], the slicer 26 determines that the constellation point corresponding to the carrier s0[1] is c[p, 1, 2], and interprets the digital information carried in the carrier s1[1] as the predetermined information SMB[p, 1, 2]. Assuming that the carrier s2[1] is located at the point sc, as the point sc falls in the decision interval d[p, 1, 1], the slicer 26 determines that the constellation point corresponding to the carrier s0[1] is c[p, 1, 1], and interprets the digital information carried in the carrier s1[1] as the predetermined information SMB[p, 1, 1].

Next, the estimation circuit 28 provides the initial signal-noise characteristic value SNRi[k] for the carrier s1[k] according to a coordinate difference between the point corresponding to the carrier s2[k] and the constellation point c[p, i1, q1] corresponding to the carriers s3[k] on the scatter plot. For example, assuming that the carriers s2[k] is located at the point sa on the scatter plot, the slicer 26 reckons that the original carrier s0[k] is located at the constellation point c[p, 1, 2], and the estimation circuit 28 regards a difference vector va between the point sa and the constellation point c[p, 1, 2] as an error caused by noises, and calculates the initial signal-noise characteristic value SNRi[k] according to a length of the vector va. Similarly, assuming that the carrier s2[k] falls at the point sb, the slicer 26 also reckons that the original carrier s0[k] is located at the constellation point c[p, 1, 2], and the estimation circuit 28 regards a difference vector vb between the point sb and the constellation point c[p, 1, 2] as an error caused by noises, and calculates the initial signal-noise characteristic value SNRi[k] according to a length of the vector vb. Because the point sb is closer to the constellation point c[p, 1, 2] than the point sa and the difference vector vb is smaller than the difference vector va, the initial signal-noise characteristic value the estimation circuit 28 obtains for the carrier s2[k] located at the point sb is higher than the initial signal-noise characteristic value the estimation circuit 28 obtains for the carrier s2[k] located at the point sa.

However, according to the above principles, since the slicer 26 cannot learn at which constellation point the carrier s0[k] originally falls when data frames are transmitted, an estimation error is caused in the estimation operation of the estimation circuit 28. For example, assuming that the original position of the carrier s0[k] of the transmitter circuit 10 is at the constellation point c[p, 1, 1], the carrier s2[k] the receiver circuit 20 obtains is shifted to the point sb due to large noises. Thus, the real signal-noise characteristic value should be calculated according to a vector difference v0 between the point sb and the constellation point c[p, 1, 1]. However, as the point sb is located in the decision interval d[p, 1, 2], the slicer 26 mistakenly reckons that the carrier s0[k] is originally at the constellation point c[p, 1, 2], in a way that the estimation circuit 28 also mistakenly obtains an incorrect signal-noise characteristic value according to the difference vector vb between the point sb and the constellation point c[p, 1, 2]. With the vector vb being shorter than the vector v0, the incorrect signal-noise characteristic value is higher than the real signal-noise characteristic value. In other words, the estimation that the estimation circuit 28 performs for the signal-noise characteristic value is too optimistic. When the signal-noise characteristic value is misestimated, the adaptive operations the network system performs according to the signal-noise characteristic value are correspondingly erroneous. For example, assuming that the receiver end mistakenly overestimates the signal-noise characteristic value, the transmitter end is mislead to mistakenly increase the data transmission rate. Although the data transmission rate is higher, the error rate is also higher because signals received by the receiver end are interfered by high noises, and the bit amount of data that is correctly and effectively transmitted is contrarily reduced.

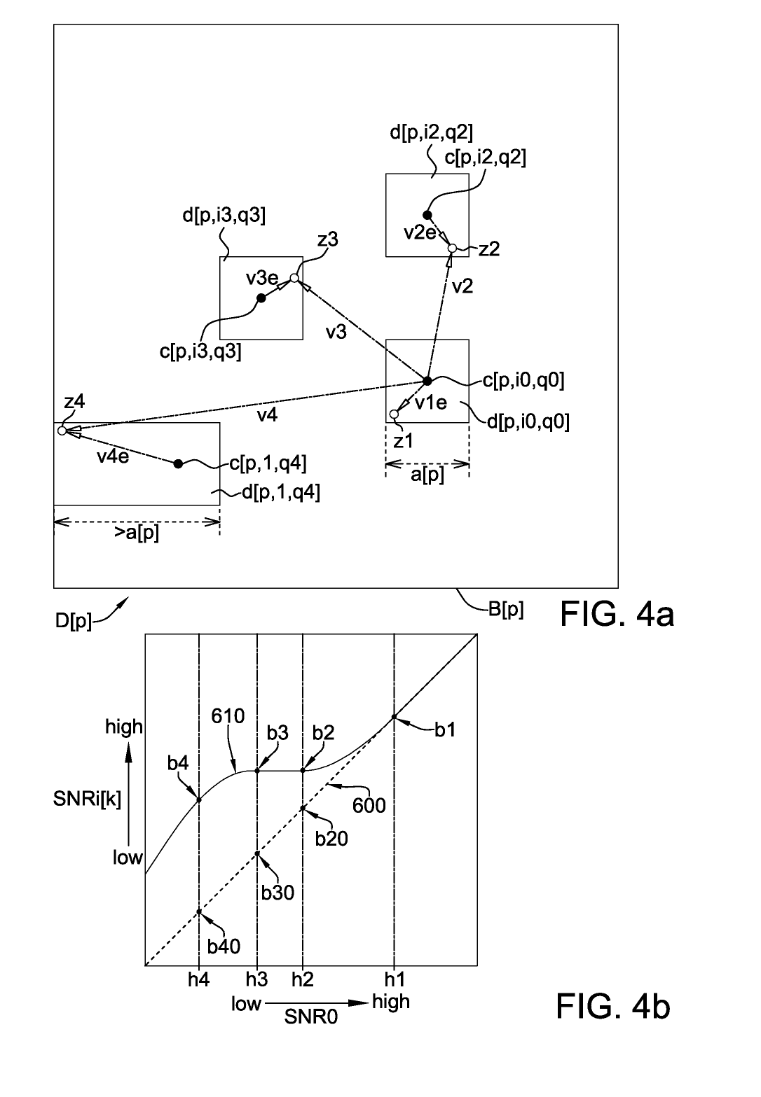

The description below is given in continuation of FIG. 1 to FIG. 3 and with reference to FIG. 4a and FIG. 4b. For the original carrier s0[k] that transmitter circuit 10 transmits according to the predetermined modulation setting MS[p], if the slicer 26 interprets the equalized carrier s2[k] as the carrier s3[k] by adopting the decision interval division D[p] with fixed borders, when the estimation circuit 28 provides the initial signal-noise characteristic value SNRi[k] according to the carriers s2[k] and s3[k], the misestimated signal-noise characteristic values may be illustrated by the distribution in the scatter plot in FIG. 4a, and FIG. 4b illustrates the comparison between real signal-noise characteristic values SNR0 (the horizontal axis, may be in a logarithmic scale) and the initial signal-noise characteristic values SNRi[k] (the vertical axis, may be in a logarithmic scale). In the example in FIG. 4a and FIG. 4b, the (real and initial) signal-noise characteristic values may refer to a signal-to-noise ratio (SNR).

The example in FIG. 4a and FIG. 4b adopt the decision interval division (D[p]) (in FIG. 4a) with fixed borders. A corresponding border decision interval (a decision interval having at least one side overlapping the border B[p]) has at least one side length greater than the distance a[p] between the constellation points, and side lengths of the remaining intervals (decision intervals having sides non-overlapping the border B[p]) are equal to the distance a[p].

As shown in FIG. 4b, a correct (ideal) relationship between the initial signal-noise characteristic value SNRi[k] and the real signal-noise characteristic value SNR0 generated by the estimation circuit 28 is expectantly linear, as shown by a straight line 600. However, under the decision interval division with fixed borders, the relationship between the initial signal-noise characteristic value SNRi[k] and the real signal-noise characteristic value SNR0 displays a curve 610. Reasons for such are given below.

In FIG. 4a, the original carrier s0[k] of the transmitter circuit 10 is formed according to the constellation point c[p, i0, q0]. When the real signal-noise characteristic value SNR0 is equal to a higher value h1 (in FIG. 4b), it means a smaller noise interference is present, and the carrier s2[k] transmitted through the channel 12 falls in the decision interval d[i, p0, q0] around the constellation point c[p, i0, q0], e.g., at a point z1. Thus, the slicer 26 correctly determines that the carrier s2[k] corresponds to the constellation point c[p, i0, q0]. When the estimation circuit 28 regards a difference vector v1e between the determined constellation point c[p, i0, q0] and the point z1 as noises to estimate the initial signal-noise characteristic value SNRi[k], the initial signal-noise characteristic value SNRi[k] is in fact quite similar to the real signal-noise characteristic value SNR0, as shown by a point b1 in FIG. 4b.

When the signal-noise characteristic value SNR0 is a smaller value h2 (h2<h1), it means that a larger noise interference is present, causing the position of the carrier s2[k] to be shifted away from the decision interval d[p, i0, q0] where the original constellation point c[p, i0, q0] is located. For example, the position of the carrier s2[k] may be shifted to a point z2 to be located in the decision interval d[p, i2, q2] of the constellation point c[p, i2, q2]. Thus, the slicer 26 may misjudge that the carrier s2[k] corresponds to the constellation point c[p, i2, q2], and the estimation circuit 28 estimates the initial signal-noise characteristic value SNRi[k] by regarding a vector difference v2e between the constellation point c[p, i2, q2] and the point z2 as noises to form a point b2 on a curve 610 (in FIG. 4b). However, as the real original constellation point is c[p, i0, q0] instead of c[p, i2, q2], the real noise should be the difference vector v2 between the constellation point c[p, i0, q0] and the point z2 instead of the vector difference v2e. That is, the correct value of the initial signal-noise characteristic value SNRi[k] should be a point b20 on the straight line 600. Because the length of the vector v2e is shorter than that of the vector v2, the initial signal-noise characteristic value SNRi[k] is higher than the real signal-noise characteristic value SNR0. In FIG. 4b, the difference between the points b2 and b20 is associated with the difference between the vectors v2e and v2.

When the signal-noise characteristic value SNR0 is an even smaller value h3 (h3<h2), it means an even larger noise interference is present, causing the carrier s2[k] to be shifted even farther away from the decision interval d[p, i0, q0] of the original constellation point c[p, i0, q0]. For example, the position of the carrier s2[k] may be shifted to a point z3 located in a decision interval d[p, i3, q3] of the constellation point c[p, i3, q3], as shown in FIG. 4a. Thus, the slicer 26 may misjudge that the carrier s2[k] corresponds to the constellation point c[p, i3, q3], and the estimation circuit 28 estimates the initial signal-noise characteristic value SNRi[k] by regarding a vector difference v3e between the constellation point c[p, i3, q3] and the point z3 as noises to form a point b3 on a curve 610 (in FIG. 4b). However, as the real original constellation point is c[p, i0, q0] instead of c[p, i3, q3], the real noise should be the difference vector v3 between the constellation point c[p, i0, q0] and the point z3 instead of the vector difference v3e. That is, the correct value of the initial signal-noise characteristic value SNRi[k] should be a point b30 on the straight line 600 to match the real signal-noise characteristic value SNR0. Because the length of the vector v3e is shorter than that of the vector v3, the initial signal-noise characteristic value SNRi[k] obtained by regarding the vector v3e as noises is higher than the real signal-noise characteristic value SNR0. In FIG. 4b, the difference between the points b3 and b30 is associated with the difference between the vectors v3e and v3. It is seen from FIG. 4a that, the difference between the vectors v3e and v3 is greater than that between the vectors v2e and v2, and so the difference between the points b3 and b30 is also greater than that between the points b2 and b20.

When the signal-noise characteristic value SNR0 is an even smaller value h4 (h4<h3), it means that an even larger noise interference is present, causing the position of the carrier s2[k] to be shifted even farther away from the decision interval d[p, i0, q0] to reach near the border B[p]. For example, the position of the carrier s2[k] may be shifted to a point z4 to be located in the decision interval d[p, 1, q4] of the constellation point c[p, 1, q4], as shown in FIG. 4a. Thus, the slicer 26 may misjudge that the carrier s2[k] corresponds to the constellation point c[p, 1, q4], and the estimation circuit 28 estimates the initial signal-noise characteristic value SNRi[k] according to the interpretation of the slicer 26 by regarding a vector difference v4e between the constellation point c[p, 1, q4] and the point z4 as noises estimate the initial signal-noise characteristic value SNRi[k] and to form a point b4 on the curve 610. However, as the real original constellation point is c[p, i0, q0] instead of c[p, 1, q4], the real noise can only be truly reflected by a difference vector v4 between the constellation point c[p, i0, q0] and the point z2 instead of the vector difference v4e. That is, the correct value of the initial signal-noise characteristic value SNRi[k] should be a point b40 on the straight line 600 to truly reflect the real signal-noise characteristic value SNR0. Because the length of the vector v4e is shorter than that of the vector v4, the initial signal-noise characteristic value SNRi[k] obtained according to the vector v4e is higher than the real signal-noise characteristic value SNR0. As shown in FIG. 4b, the difference between the points b4 and b40 is associated with the difference between the vectors v4e and v4.

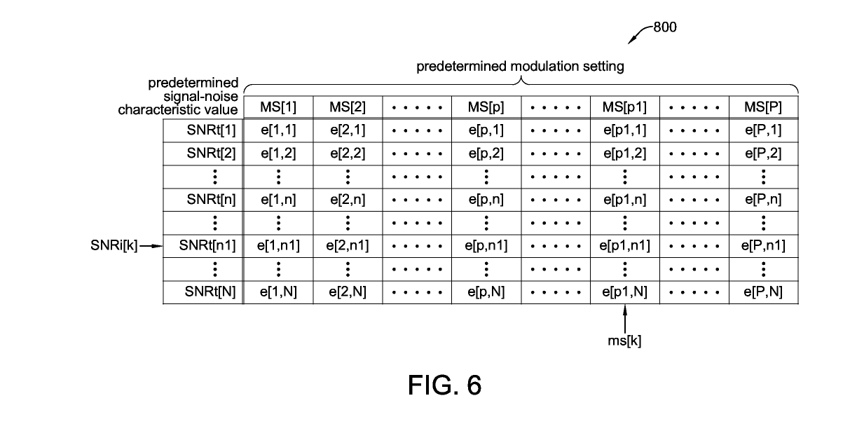

As shown in FIG. 4a, the decision intervals d[p, i2, q2] and d[p, i3, q3] where the points z2 and z3 are located may not be border decision intervals, and so the lengths of the vectors v2e and v3e are limited by the distance a[p]/2. However, under the decision interval division with fixed borders, the border decision interval has at least one side length greater than the distance a[p]. Thus, the length of the vector v4e is not limited by the distance a[p]/2, and the initial signal-noise characteristic value SNRi[k] is reduced to become more similar to the real signal-noise characteristic value SNR0, and so the height of the corresponding point b4 (in FIG. 6b) is lower than the heights of the points b2 and b3 at the vertical axis.

That is, under the decision interval division with fixed borders, as the real signal-noise characteristic value SNR0 reduces from h1 to h2, h3 and h4, the initial signal-noise characteristic value SNRi[k] first gradually shifts away from the real signal-noise characteristic value SNR0 (e.g., the trend of the curve 610 between the values h1 and h3), and then approaches the real signal-noise characteristic value SNR0 (e.g., the trend of the curve 610 between the points h3 and h4). One reason causing the above is that, a border decision interval with a larger size has more space for reflecting a longer noise vector (e.g., v4e), such that the noise vector is not limited by non-border decision intervals with a smaller size.

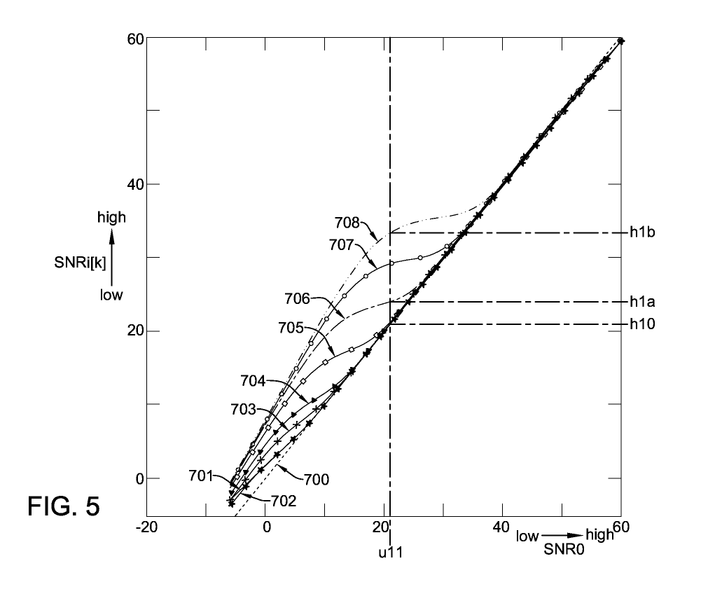

The description below is given in continuation of FIGS. 4a and 4b and with reference to FIG. 5. Under a decision interval decision with fixed borders, assume that the modulation setting ms[k] adopted by the carrier s0[k] is BPSK, QPSK, 8QAM, 16QAM, 64QAM, 256QAM, 1024QAM or 4096QAM to carry 1-bit, 2-bit, 3-bit, 4-bit, 6-bit, 8-bit, 10-bit or 12-bit digital information within one unit time. Thus, the relationship between the initial signal-noise characteristic value SNRi[k] (the vertical axis, may be in a logarithmic scale, e.g., in a unit of decibels) and the real signal-noise characteristic value SNR0 (the horizontal axis, may be in a logarithmic scale, e.g., in a unit of decibels) may be presented by a curve 701, 702, 703 704, 705, 706, 707 or 708 (where the curves 701 and 702 almost overlap). In contrast, the relationship between the initial signal-noise characteristic value SNRi[k] and the real signal-noise characteristic value SNR0 is expectantly a linear relationship as a straight line 700. For example, when the real signal-noise characteristic value SNR0 is equal to a value u11, the correct value of the initial signal-noise characteristic value SNRi[k] should be equal to a value h10. However, as shown in FIG. 5, under the same real signal-noise characteristic value SNR0, as the bit count the modulation setting ms[k] carries within one unit time gets larger, the difference between the initial signal-noise characteristic value SNRi[k] and the real signal-noise characteristic value SNR0 also gets larger. For example, when the real signal-noise characteristic value SNR0 is equal to the value h10, if the modulation setting ms[k] is 256QAM that carries a 6-bit symbol within one unit time, the initial signal-noise characteristic value SNRi[k] is mistakenly overestimated as a value h1 a; if the modulation setting ms[k] is 4096 that carries a 12-bit symbol within one unit time, the initial signal-noise characteristic value SNRi[k] is mistakenly overestimated as a value h1 b, and h1b>h1a>h10. As the bit count carried within one unit time gets larger, the shortest distance between adjacent constellation points also gets shorter, and the size of non-border decision intervals also gets smaller. When the value of the real signal-noise characteristic value SNR0 is not excessively small (e.g., greater than the value u11), the noise vector misestimated by the estimation circuit 28 is more likely to fall within the same non-border decision interval. As a non-border decision interval gets smaller, the initial signal-noise characteristic value SNRi[k] the estimation circuit 28 provides is likely overestimated to have an even larger difference from the real signal-noise characteristic value SNR0.

On the other hand, when the value of the real signal-noise characteristic value SNR0 is even smaller (e.g., smaller than the value u11), the noise vector misestimated by the estimation circuit 28 more likely falls in a border decision interval. As previously described, under a decision interval division with fixed borders, side lengths of non-border decision intervals of different predetermined modulation settings MS[p1] and MS[p2] are respectively equal to distances a[p1] and a[p2] between the constellation points, and a border decision interval has at least one longer side having a side length larger than the distances a[q1] and a[p2] between the constellation points. For example, assume that the predetermined modulation settings MS[p1] and MS[p2] are 256QAM and 4096QAM, a ratio between the side length of the non-border decision interval to the distances a[p1] and a[p2] is approximately 4:1, with the longer sides of the border decision interval however being substantially equal. Therefore, when the real signal-noise characteristic value SNR0 is larger, since the initial signal-noise characteristic value is more associated with the side lengths of the non-border decision intervals and a larger difference exists between the side lengths of the two non-border decision intervals, the difference between the initial signal-noise characteristic values under these two predetermined modulation settings is larger (e.g., the difference between the values h1 a and h2a). On the other hand, when the real signal-noise characteristic value SNR0 is smaller, since the initial signal-noise characteristic value is more associated with the side lengths of the longer sides of the non-border decision intervals and a smaller difference exists between the side lengths of the longer sides of the two non-border decision intervals, the difference between the initial signal-noise characteristic values under these two predetermined modulation settings is smaller to be similar to each other.

To correct the difference between the initial signal-noise characteristic value SNRi[k] and the real signal-noise characteristic value SNR0, the transmitter circuit 10 includes the correction circuit 30. Again referring to FIG. 1, in the transmitter circuit 10, the correction circuit 30 is coupled to the estimation circuit 28. The estimation circuit 28 provides a corresponding correction value r[k] for each of the carriers s1[k] according to the value of the initial signal-noise characteristic value SNRi[k] of the carrier s1[k], and corrects the initial signal-noise characteristic value SNRi[k] according to the corresponding correction value r[k] to generate a corrected signal-noise characteristic value SNRc[k] for the carrier s1[k], where k=1 to K.

In one embodiment, the correction circuit 30 may include a look-up table (LUT) circuit 34 and a multiplier 32. The multiplier 32 is coupled to the LUT circuit 34 and the correction circuit 30. In continuation of FIG. 1, FIG. 6 shows a table according to an embodiment of the present invention. In an embodiment of the present invention, the LUT circuit 34 records a table 800, which stores a plurality of predetermined correction values e[p, 1] to e[p, N] for the predetermined modulation settings MS[p] (where p=1 to P), and provides the corresponding correction value r[k] for each of the carriers s1[k] according to the corresponding modulation setting ms[k] of the carrier s1[k], the signal signal-noise characteristic value SNRi[k] of the carrier s1[k], and the predetermined modulation settings MS[p] (where p=1 to P), where k=1 to K. Each of the predetermined correction values e[p, n] of the predetermined modulation settings MS[p] is associated with one SNRt[n] of a plurality of predetermined signal-noise characteristic value SNRt[1] to SNRt[N]. In one embodiment, the network system only utilizes one setting (i.e., K=1), e.g., the predetermined modulation setting MS[1]. Thus, the table 800 can include only one column for recording the predetermined correction values e[1, 1] to e[1, N].

In one embodiment, the LUT circuit 34 identifies the predetermined modulation setting MS[p1] (e.g., QPSK) satisfying the modulation setting ms[k] (e.g., QPSK) corresponding to the carrier s1[k] from the predetermined modulation settings MS[1] to MS[P]. In one embodiment, the LUT circuit 34 identifies a predetermined signal-noise characteristic value SNRt[n1] (e.g., −4 db) that is closest to the initial signal-noise characteristic value SNRi[k] for the carrier s1[k] from the predetermined signal-noise characteristic value SNRt[1] to SNRt[N]. Thus, the LUT circuit 34 identifies the corresponding correction value e[p1, n1] according to the predetermined modulation setting MS[p1] and the predetermined signal-noise characteristic value SNRt[n1] to serve as the corresponding correction value r[k] of the carrier s1[k]. In another embodiment, the LUT circuit 34 identifies two predetermined signal-noise characteristic values SNRt[n1] and SNRt[n2] (e.g., −0.3 db and −4 db) that are closest to upper and lower limits of the initial signal-noise characteristic value SNRi[k] (e.g., −3.6 db) for the carrier s1[k] from the predetermined signal-noise characteristic values SNRt[1] to SNRt[N]. Thus, the LUT circuit 34 identifies the predetermined correction values e[p1, n1] and e[p1, n2] according to the predetermined modulation setting MS[p1] and the predetermined signal-noise characteristic value SNRt[n1] and SNRt[n2], performs interpolation on the predetermined correction values e[p1, n1] and e[p1, n2] according to the initial signal-noise characteristic value SNRi[k] and the predetermined signal-noise characteristic value SNRt[n1] and SNRt[n2], and utilizes the interpolated result as the corresponding correction value r[k] of the carrier s1[k].

Using the initial signal-noise characteristic value SNRi[k] and the corresponding correction value r[k] provided by the estimation circuit 28 and the LUT circuit 34, the multiplier 32 (in FIG. 1) may multiply the initial signal-noise characteristic value SNRi[k] by the corresponding correction value r[k], and accordingly generate the corrected signal-noise characteristic value SNRc[k] according to a product r[k]*SNRi[k].

The predetermined correction values e[p, n] in the table 800 (in FIG. 6) may be obtained through value simulation. For example, to correct the misestimated initial signal-noise characteristic value SNRi[k] under a decision interval division with fixed borders in FIG. 4b and FIG. 5, the carrier s2[k] affected by noises (e.g., AWGN) can be obtain through simulation under conditions where the real signal-noise characteristic value SNR0 is equal to a predetermined signal-noise characteristic value SNRt[n] and the modulation setting ms[k] is equal to a predetermined modulation setting MS[p]. Further, hard decision operations of the slicer 26 under the decision interval division with fixed borders and estimation operations of the estimation circuit 28 for the signal-noise characteristic values of the carriers s2[k] and s3[k] can be simulated. Accordingly, the initial signal-noise characteristic value SNRi[k] generated by the estimation circuit 28 can be obtained through simulation. As such, the predetermined correction value e[p, n] can be calculated according to the ratio SNRt[n]/SNRi[k].

Below is an example of the table 800 for correcting an initial signal-noise characteristic value under a decision interval division with fixed borders. In the example, the predetermined modulation settings MS[1] to MS[P] are respectively BPSK, QPSK, 8QAM, 16QAM, 64QAM, 256QAM, 1024QAM and 4096QAM (where P may equal to 8), and the predetermined signal-noise characteristic values SNRt[1] to SNRt[N] are arranged in an increasing order, from −6 db to 41 db (where N may be equal to 48).

| Predetermined | | | | | | | | | |
|---|---|---|---|---|---|---|---|---|---|
| signal-noise | | Predetermined modulation setting | | | | | | | |
| characteristic | | MS[1] | MS[2] | MS[3] | MS[4] | MS[5] | MS[6] | MS[7] | MS[8] |
| value (in db) | | BPSK | QPSK | 8 QAM | 16 QAM | 64 QAM | 256 QAM | 1024 QAM | 4096 QAM |
| SNRt[1] | −6 | 0.48765815 | 0.58687605 | 0.5039086 | 0.41962643 | 0.34949602 | 0.31525811 | 0.30084342 | 0.29292104 |
| SNRt[2] | −5 | 0.48765815 | 0.58687605 | 0.5039086 | 0.41962643 | 0.34949602 | 0.31525811 | 0.30084342 | 0.29292104 |
| SNRt[3] | −4 | 0.48765815 | 0.58687605 | 0.5039086 | 0.41962643 | 0.34949602 | 0.31525811 | 0.30084342 | 0.29292104 |
| SNRt[4] | −3 | 0.48765815 | 0.59034028 | 0.5039086 | 0.41962643 | 0.34949602 | 0.31525811 | 0.30084342 | 0.29292104 |
| SNRt[5] | −2 | 0.51974873 | 0.59276789 | 0.49501687 | 0.41962643 | 0.34949602 | 0.31525811 | 0.30084342 | 0.29292104 |
| SNRt[6] | −1 | 0.57019969 | 0.60106259 | 0.48589319 | 0.40265424 | 0.34949602 | 0.31525811 | 0.30084342 | 0.29292104 |
| SNRt[7] | 0 | 0.60022559 | 0.6133937 | 0.47717746 | 0.38911551 | 0.32830934 | 0.2946178 | 0.30084342 | 0.29292104 |
| SNRt[8] | 1 | 0.62895634 | 0.63589002 | 0.47180844 | 0.3726019 | 0.30796244 | 0.2946178 | 0.278587 | 0.26976091 |
| SNRt[9] | 2 | 0.66785169 | 0.66897898 | 0.47037987 | 0.36051333 | 0.28558904 | 0.27221957 | 0.25559839 | 0.24857742 |
| SNRt[10] | 3 | 0.75153036 | 0.7492202 | 0.47448829 | 0.36051333 | 0.28558904 | 0.24844821 | 0.23043805 | 0.24857742 |
| SNRt[11] | 4 | 0.79736888 | 0.7995527 | 0.49019179 | 0.3511305 | 0.26593899 | 0.22538981 | 0.23043805 | 0.22368634 |
| SNRt[12] | 5 | 0.89472517 | 0.89197543 | 0.50690903 | 0.34584424 | 0.24728151 | 0.22538981 | 0.20869048 | 0.2014758 |
| SNRt[13] | 6 | 0.92984377 | 0.93158074 | 0.57126247 | 0.34328511 | 0.23289932 | 0.20646568 | 0.18888931 | 0.18114964 |
| SNRt[14] | 7 | 0.9618433 | 0.95774448 | 0.6201684 | 0.36446749 | 0.23289932 | 0.18929631 | 0.18888931 | 0.18114964 |
| SNRt[15] | 8 | 0.97981888 | 0.98118366 | 0.72851 | 0.38391342 | 0.2218235 | 0.18929631 | 0.1700828 | 0.16234126 |
| SNRt[16] | 9 | 0.99501974 | 0.99054564 | 0.78735877 | 0.44961517 | 0.21185203 | 0.17448584 | 0.15431171 | 0.14486927 |
| SNRt[17] | 10 | 0.99505001 | 0.99596715 | 0.8943135 | 0.50043795 | 0.20525182 | 0.16090547 | 0.15431171 | 0.14486927 |
| SNRt[18] | 11 | 0.99705413 | 0.99953286 | 0.93172676 | 0.62531483 | 0.2011854 | 0.14833057 | 0.13889803 | 0.13051405 |
| SNRt[19] | 12 | 0.99956524 | 1.0012285 | 0.96019394 | 0.76963131 | 0.20023023 | 0.14833057 | 0.12703285 | 0.11760134 |
| SNRt[20] | 13 | 1.0002416 | 1.0019797 | 0.98353246 | 0.89577786 | 0.20421777 | 0.13955223 | 0.11441376 | 0.11760134 |
| SNRt[21] | 14 | 0.99960446 | 0.99903104 | 0.99294012 | 0.94124953 | 0.22575578 | 0.13164236 | 0.11441376 | 0.10543288 |
| SNRt[22] | 15 | 0.99474612 | 0.99980674 | 0.99698666 | 0.96806659 | 0.24358571 | 0.12542023 | 0.10580812 | 0.094649713 |
| SNRt[23] | 16 | 1.0002612 | 1.0005114 | 1.0002276 | 0.98948145 | 0.30270847 | 0.11975363 | 0.096859651 | 0.094649713 |
| SNRt[24] | 17 | 1.0004014 | 0.99880149 | 0.99845074 | 0.9926749 | 0.46729047 | 0.11776468 | 0.089420563 | 0.08653779 |
| SNRt[25] | 18 | 1.0002507 | 0.99942773 | 0.99672439 | 0.99984503 | 0.71291224 | 0.11764868 | 0.089420563 | 0.078127297 |
| SNRt[26] | 19 | 0.99698159 | 1.0005525 | 1.000527 | 0.99800179 | 0.79537715 | 0.11999268 | 0.083177277 | 0.078127297 |
| SNRt[27] | 20 | 1.0009204 | 0.99765919 | 0.9997663 | 0.99828361 | 0.92061495 | 0.12500003 | 0.078775596 | 0.070464537 |
| SNRt[28] | 21 | 1.0004936 | 1.0002754 | 0.9982702 | 1.0001718 | 0.95867231 | 0.14578325 | 0.074331946 | 0.063707549 |
| SNRt[29] | 22 | 1.0011614 | 0.99951151 | 1.0011298 | 0.99928842 | 0.9817432 | 0.1828221 | 0.071579342 | 0.05897092 |
| SNRt[30] | 23 | 0.9994926 | 1.001958 | 1.0006843 | 0.99808539 | 0.99039468 | 0.29524163 | 0.071579342 | 0.05897092 |
| SNRt[31] | 24 | 0.99746757 | 0.99896648 | 0.99895411 | 1.003806 | 1.0006579 | 0.59511539 | 0.070456051 | 0.053665799 |
| SNRt[32] | 25 | 1.0017339 | 0.99989631 | 0.99888589 | 0.99936891 | 1.00158 | 0.77518384 | 0.071239654 | 0.050511678 |
| SNRt[33] | 26 | 0.99849393 | 0.99803248 | 0.99771645 | 1.0024362 | 1.0014023 | 0.91264774 | 0.074553339 | 0.047275867 |
| SNRt[34] | 27 | 1.0006838 | 1.0009766 | 0.99819792 | 0.9984546 | 1.0045138 | 0.95520855 | 0.079120077 | 0.044761074 |
| SNRt[35] | 28 | 1.0011956 | 0.99937898 | 1.0000517 | 1.0012247 | 0.99848644 | 0.98055498 | 0.097017281 | 0.044761074 |
| SNRt[36] | 29 | 1.0007062 | 0.99876081 | 1.0025064 | 1.0004082 | 0.99976822 | 0.99353016 | 0.18290965 | 0.043140403 |
| SNRt[37] | 30 | 0.99945345 | 1.0012934 | 1.000627 | 1.0023583 | 0.9995312 | 0.99884933 | 0.57846912 | 0.041845716 |
| SNRt[38] | 31 | 1.0003553 | 0.99996498 | 0.99907701 | 1.0005876 | 1.0004187 | 0.99861056 | 0.76378084 | 0.042598813 |
| SNRt[39] | 32 | 0.99800422 | 0.99927754 | 0.99943278 | 1.0004042 | 1.0011249 | 1.001415 | 0.90828023 | 0.042839353 |
| SNRt[40] | 33 | 0.99872404 | 1.0006759 | 1.0016668 | 0.99842341 | 0.99840288 | 1.0006056 | 0.95080647 | 0.04751887 |
| SNRt[41] | 34 | 0.99659692 | 1.0016014 | 1.0006996 | 0.99920152 | 1.0005797 | 1.0011793 | 0.97988884 | 0.058710246 |
| SNRt[42] | 35 | 1.0013068 | 1.0020172 | 1.0011535 | 1.0008547 | 1.0018443 | 1.0006153 | 0.99058845 | 0.11323584 |
| SNRt[43] | 36 | 0.99793686 | 1.0006099 | 1.0014654 | 0.99929371 | 1.0029228 | 1.0007618 | 0.99839849 | 0.56988764 |
| SNRt[44] | 37 | 1.0013533 | 1.0029146 | 1.0008827 | 0.99755658 | 1.0026438 | 1.0050494 | 1.00129 | 0.75957146 |
| SNRt[45] | 38 | 0.99858228 | 0.99983476 | 1.000301 | 0.99718821 | 1.0003093 | 1.0010478 | 1.0016351 | 0.90487368 |
| SNRt[46] | 39 | 1.0016232 | 0.99810046 | 1.0027333 | 0.99968891 | 1.0017996 | 1.0025142 | 1.0007974 | 0.95156315 |
| SNRt[47] | 40 | 1.0002103 | 1.0006737 | 1.001825 | 1.005349 | 1.0034358 | 1.0010279 | 1.0015287 | 0.97746547 |
| SNRt[48] | 41 | 1.0018543 | 1.001628 | 1.0020041 | 1.000652 | 1.0030958 | 1.0021397 | 1.0016688 | 0.99407122 |

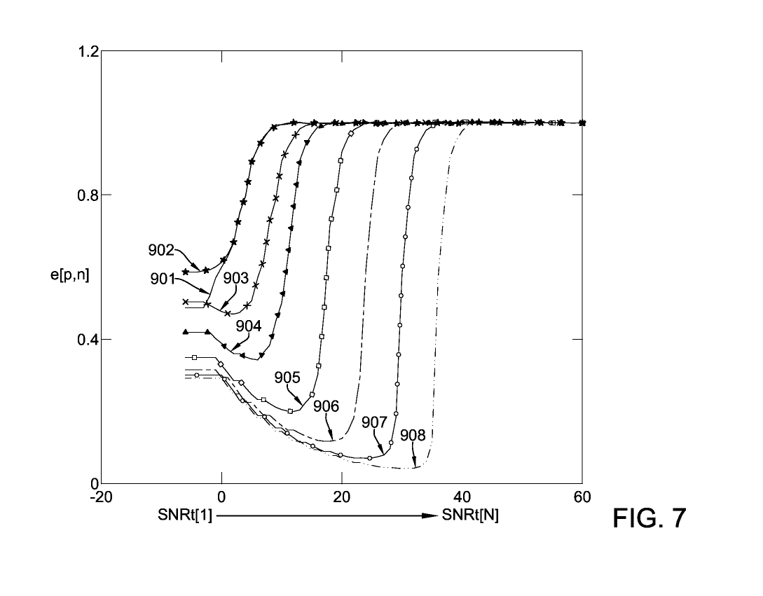

The above exemplary table may also be illustrated in FIG. 7, where the horizontal axis represents the predetermined signal-noise characteristic values SNRt[1] to SNRt[N] (may be in a logarithmic scale, e.g., in a unit of decibels), and the vertical axis represents values of the predetermined correction values e[p, n] (may be in a logarithmic scale). In FIG. 7, a curve 901 shows the predetermined correction values e[1, 1] to e[1, N] associated with the predetermined modulation settings MS[1] (i.e., BPSK), a curve 902 shows the predetermined correction values e[2, 1] to e[2, N] associated with the predetermined modulation setting MS[2] (i.e., QPSK), a curve 903 shows the predetermined correction values e[3, 1] to e[3, N] associated with the predetermined modulation settings MS[3] (i.e., 8QAM), a curve 904 shows the predetermined correction values e[4, 1] to e[4, N] associated with the predetermined modulation settings MS[4] (i.e., 16QAM), a curve 905 shows the predetermined correction values e[5, 1] to e[5, N] associated with the predetermined modulation settings MS[5] (i.e., 64QAM), a curve 906 shows the predetermined correction values e[6, 1] to e[6, N] associated with the predetermined modulation settings MS[6] (i.e., 256QAM), a curve 907 shows the predetermined correction values e[7, 1] to e[7, N] associated with the predetermined modulation settings MS[7] (i.e., 1024QAM), and a curve 908 shows the predetermined correction values e[8, 1] to e[8, N] associated with the predetermined modulation settings MS[8] (i.e., 4096QAM).

It is seen from the above exemplary table and FIG. 7 that, with the predetermined signal-noise characteristic values SNRt[1] to SNRt[N] arranged in an increasing order, changes of at least a partial number of predetermined correction values in the predetermined correction values e[p, 1] to e[p, N] of the same predetermined modulation setting MS[p] first display an increasing/decreasing trend (e.g., monotonically increasing or strictly decreasing) and then display a second increasing/decreasing trend, with the first increasing/decreasing order and the second increasing/decreasing order being opposite each other. If the initial signal-noise characteristic value SNRi[k] is greatly shifted, the correction circuit 30 (in FIG. 1) selects a smaller predetermined correction value e[p, n] as the corresponding correction value r[k] in order to allow the multiplier 32 to multiply a larger initial signal-noise characteristic value SNRi[k] into a smaller corrected signal-noise characteristic value SNRc[k]. Thus, with the predetermined signal-noise characteristic value SNRt[1] changing to the larger SNRt[N], at least a partial number of predetermined signal-noise characteristic values e[p, n] first change from large to small (decreasing) and then from small to large (increasing).

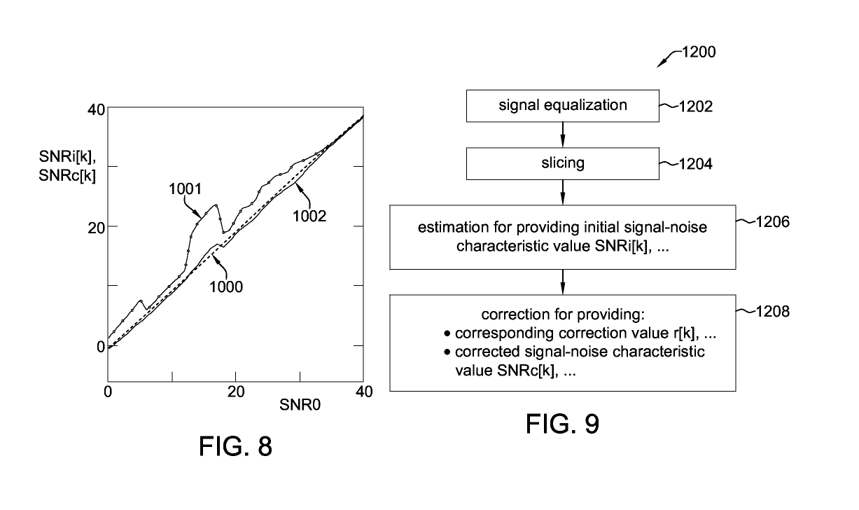

In the example in the above table and FIG. 7, with the bit counts the predetermined modulation settings MS[1] to MS[P] carry within one unit time arranged in an increasing order, in the predetermined correction values e[1, n] to e[P, n] associated with the same predetermined signal-noise characteristic values SNRt[n] and belonging to different predetermined modulation settings, at least a partial number of predetermined correction values e[1, n] to e[P, n] display a decreasing trend. For example, under the same predetermined signal-noise characteristic value SNRt[12], the predetermined correction values e[1, 12] to e[8, 12] display a decreasing trend. Similarly, under the same predetermined signal-noise characteristic value SNRt[21], the predetermined e[1, 21] to e[8, 21] display a decreasing trend. As shown in FIG. 5, under the same real signal-noise characteristic value SNR0 (e.g., the value h1), the predetermined modulation setting MS[p1] (e.g., 4096QAM of the curve 708) that carries a larger bit count within one unit time is farther away from the real signal-noise characteristic value SNR0 than the predetermined modulation setting MS[p2] (e.g., 256QAM of the curve 706) that carries a smaller bit count. Thus, the predetermined modulation setting MS[p1] that carries a larger bit count within one unit time requires a smaller predetermined signal-noise characteristic value e[p1, n] to be more significantly down-sized by the multiplication. In continuation of the above table and FIG. 7, FIG. 8 shows uncorrected initial signal-noise characteristic values SNRi[k] and corrected signal-noise characteristic values SNRc[k]. In FIG. 7, the horizontal axis represents the real signal-noise characteristic value SNR0 (may be in a logarithmic scale, in a unit of decibels) the receiver circuit 20 receives, and the vertical axis represents the values of the initial signal-noise characteristic value SNRi[k] or the corrected signal-noise characteristic value SNRc[k]. If the receiver circuit 20 estimates the signal-noise characteristic value according to a sounding packet, the relationship between the changes in the signal-noise characteristic value and the real signal-noise characteristic value SNR0 may be illustrated by a curve 1000. As contents of the sounding packet are known to the receiver circuit 20 in advance, the curve 1000 may represent ideal conditions for the estimation of the signal-noise characteristic value. In contrast, if the receiver circuit 20 estimates the initial signal-noise characteristic value SNRi[k] according to data frames received, the relationship between the initial signal-noise characteristic value SNRi[k] and the real signal-noise characteristic value SNR0 may be represented by a curve 1001. As digital information in the data frames is not known to the receiver circuit 20 in advance, the initial signal-noise characteristic value SNRi[k] is mistakenly overestimated, such that the curve 1001 is deviated from the curve 1000. In comparison, a curve 1002 illustrates the relationship between the corrected signal-noise characteristic value SNRc[k] compensated by the correction circuit 30 and the real signal-noise characteristic value SNR0. It is seen from FIG. 8 that, compared to the initial signal-noise characteristic values represented by the curve 1001, the corrected signal-noise characteristic values represented by the curve 1002 are very similar to the curve 1000, meaning that the correction circuit 30 is capable of correcting misestimated initial signal-noise characteristic values such that the corrected signal-noise characteristic values are similar to ideal conditions.

Again referring to FIG. 1, in a state-of-the-art modern network system, signal transmission and/or reception operations can be adaptively adjusted according to the signal-noise characteristic value the receiver estimates 20. The application circuit 36 in the receiver circuit 20 is adapted to assist the above adaptive operations according to the corrected signal-noise characteristic value SNRc[1] to SNRc[K]. For example, the application circuit 36 may include a bit loading setting circuit 38 coupled to the correction circuit 30. The bit loading setting circuit 38 updates the corresponding modulation setting ms[k] of each of the carriers s0[k] according to the corrected signal-noise characteristic value SNRc[k] of the each of the carriers s1[k], where k=1 to K. The updated corresponding modulation setting ms[k] may be fed back to the transmitter circuit 10 by a feedback signal s4, and the transmitter circuit 10 may then carry subsequent digital information on the carriers s0[k] according to the updated corresponding modulation setting ms[k]. For example, assume that the transmitter circuit 10 first adopts a predetermined modulation setting MS[p1] as the corresponding modulation setting ms[k] of the carriers s0[k]. If the receiver circuit 20 obtains the corrected signal-noise characteristic value SNRc[k] with a better value (a higher value) after the reception, it means that the current information transmission conditions of the channel 12 are satisfactory, and so the bit loading setting circuit 38 feeds such information back to the transmitter circuit 10 to prompt the transmitter circuit 10 to adopt another predetermined modulation setting MS[p2] as the corresponding modulation setting ms[k] of the carriers s0[k]. The bit count (i.e., the bit loading) the predetermined modulation setting MS[p2] carries within one unit time may be higher than that carried by the previous predetermined modulation setting MS[p1]. Thus, the throughput of information transmission can be effectively increased. For example, the receiver circuit 20 may feed back a tone-map to the transmitter circuit 10, with the tone-map describing the corresponding modulation settings ms[1] to ms[K] the carriers s0[1] to s0[K] should adopt.

In contrast, if the receiver circuit 20 obtains a corrected signal-noise characteristic value SNRc[k] with a poorer value (i.e., a lower value), it means that the current information transmission conditions of the channel 12 are unsatisfactory, and so the bit loading setting circuit 38 may feed such information back to the transmitter circuit 10 to prompt the transmitter circuit 10 to switch to the previous predetermined modulation setting MS[p1], or to switch to another predetermined modulation setting MS[p3] as the corresponding modulation setting ms[k] of the carriers s0[k]. The bit loading of the predetermined modulation setting MS[p3] may be lower than that of the previously adopted predetermined modulation setting MS[p1]. Thus, the accuracy of the digital information transmission can be prevented from being affected by the noise interference.

However, the premise of the above estimation operations is that the signal-noise characteristic value estimated by the receiver circuit 30 is close to the real signal-noise characteristic value. If the signal-noise characteristic value estimated by the receiver circuit 30 differs significantly from the real signal-noise characteristic value, the adaptive operations the network system performs according to the estimated signal-noise characteristic value contrarily affects the accuracy of the operations of the network system. For example, assume that the bit loading setting circuit 38 operates according to the initial signal-noise characteristic value SNRi[k] instead of the corrected signal-noise characteristic value SNRc[k], since the initial signal-noise characteristic value SNRi[k] is more optimistic and is higher than the real signal-noise characteristic value, the bit loading setting circuit 38 will mislead the transmitter circuit 10 to switch to adopt a modulation setting with a higher bit loading in order to increase the data transmission throughput. Although the data throughput is higher, as the signals s1[k] received by the receiver circuit 20 are interfered by high noises and the amount of data effectively transmitted is reduced, the error rate is higher.

Not limited to properties of adaptive bit loading, the signal-noise characteristic value estimated by the receiver circuit 20 may include other advanced functions, e.g., soft-bit decoding, soft decision decoding, adaptive modulation and coding (AMC), turbo decoding and/or dynamic power control. These advanced functions require exceptional signal-noise characteristic values to operate correctly and effectively. The corrected signal-noise characteristic values SNRc[k] corrected by the correction circuit 30 of the present invention exactly satisfy such requirement of these advanced functions. Correspondingly, the application circuit 36 in FIG. 1 may further include circuits that support these advanced functions, e.g., a soft decision decoding circuit (not shown), which may be coupled to the correction circuit 30 and applies the corrected signal-noise characteristic value SNRc[k] the correction circuit 30 generates.

In continuation of FIG. 1, FIG. 9 shows a process 1200 according to an embodiment of the present invention. The receiver circuit 20 in FIG. 1 may be implemented in the process 1200 to correct a signal-noise characteristic value. The process 1200 mainly includes following steps.

In step 1202, an equalized signal s2 is provided by the equalizer 24 in the receiver circuit 20 according to a received signal s1. The received signal s1 includes K (greater than or equal to 1) carriers s1[1] to s1[K], and corresponding digital information is carried on the carrier s1[k] according to a corresponding modulation setting ms[k]. The corresponding modulation setting ms[k] is selected from P (greater than or equal to 1) predetermined modulation settings MS[1] to MS[P]. The equalizer 24 performs equalization on the carrier s1[k] to generate a carrier s2[k] in the equalized signal s2.

In step 1204, a slicing step is performed by the slicer 26. The slicer 26 interprets the digital information smb[k] carried in the carrier s1[k] in the equalized signal s2 to accordingly provide a sliced signal that includes carriers s3[1] to s3[K]. For example, when the corresponding modulation setting ms[k] of the carries s2[k] satisfies the predetermined modulation setting MS[p], the slicer 26 may adopt the decision interval division D[p] in FIG. 3. Accordingly, the slicer 26 determines that the carrier s2[k] falls in the decision interval d[p, i, q] according to the position of the carrier s2[k] on the scatter plot, and interprets that the digital information smb[k] carried in the carrier s2[k] as being associated with the predetermined information SMB[p, q] corresponding to the constellation point c[p, i, q] to reflect the carrier s3[k]. As previously discussed (e.g., in FIG. 3), the decision interval division D[p] adopted by the slicer 2 may be a decision interval decision with fixed borders.

In step 1206, the estimation circuit 28 performs an estimation step to provide an initial signal-noise characteristic value SNRi[k] for each carrier s1[k] according to the equalized signal s2 and the sliced signal s3. For example, when the slicer 26 interprets the carrier s2[k] as the constellation point c[p, i, q], the estimation circuit 28 may estimate the initial signal-noise characteristic value SNRi[k] according to a difference vector between the carrier s2[k] and the constellation point c[p, i, q] on the scatter plot.

In step 1208, the correction circuit 30 performs a correction step to provide a corresponding correction value r[k] according to the initial signal-noise characteristic value SNRi[k] of each carrier s1[k], and to correct the initial signal-noise characteristic value SNRi[k] according to the corresponding correction value r[k] of the carrier s1[k] to generate a corrected signal-noise characteristic value SNRc[k] for the carrier s1[k]. For example, the LUT circuit 34 may store N (greater than 1) predetermined correction values e[p, 1] to e[p, N] for the predetermined modulation settings MS[p], and provide the corresponding correction value r[k] for each carrier s1[k] according to the corresponding modulation setting ms[k] of the carrier s1[k], the initial signal-noise characteristic value SNRi[k] of the carrier s1[k], and the predetermined correction values e[1, 1] to e[P, N] of the predetermined modulation settings MS[1] to MS[P]. Further, the multiplier 32 multiples the initial signal-noise characteristic value SNRi[k] of each carrier s1[k] by the corresponding correction value r[k[of the carrier s1[k] to accordingly generate the corrected signal-noise characteristic value SNRc[k] of the carrier s1[k]. Each of the predetermined correction values e[p, n] of the predetermined modulation setting MS[p] is associated with one predetermined signal-noise characteristic value SNRt[n] of N predetermined signal-noise characteristic values SNRt[1] to SNRt[N].

When the LUT circuit 34 provides the corresponding correction value r[k] for each carrier s1[k], the predetermined modulation setting MS[p] satisfying the corresponding modulation setting ms[k] is identified from the predetermined modulation settings MS[1] to MS[P], and the predetermined signal-noise characteristic value SNRt[n] that is closest to the initial signal-noise characteristic value SNRi[k] of the carrier s1[k] is identified from the predetermined signal-noise characteristic values SNRt[1] to SNRt[N], so as to utilize the predetermined correction value e[p, n] associated with the predetermined signal-noise characteristic value SNRt[n] from the predetermined correction values e[p, 1] to e[p, N] of the predetermined modulation MS[p] as the corresponding correction value r[k] of the carrier s1[k].

The process 1200 may be implemented by hardware, software, firmware or a combination of the three. For example, step 1208 may be performed by the correction circuit 30 in form of hardware, and the LUT circuit 34 may include a static random access memory (SRAM) for storing the table 800 (in FIG. 6). Alternatively, step 1208 may be performed by a processor (not shown) through executing software and/or firmware, and the table 800 may be stored by a DRAM.

In conclusion, the present invention is capable of improving (correcting) a signal-noise characteristic value that a receiver end estimates. For example, the receiver end may mistakenly overestimate the signal-noise characteristic value due to a hard-decision operation of a slicer, and the present invention is capable of adaptively down-size the overestimated signal-noise characteristic value to a more accurate corrected signal-noise characteristic value. Thus, a network system is allowed to correctly determine communication (e.g., channel) conditions according to the corrected signal-noise characteristic value, and to correctly perform adaptive transmission/reception adjustments, e.g., adjusting the bit loading setting of the carriers.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A receiver circuit capable of correcting a signal-noise characteristic value, comprising:
an equalizer, providing an equalized signal according a received signal;
a slicer, coupled to the equalizer, providing a sliced signal according to the equalized signal;
an estimation circuit, coupled to the equalizer and the slicer, providing an initial signal-noise characteristic value according to a difference between the equalized signal and the sliced signal; and
a correction circuit, coupled to the estimation circuit, providing a corresponding correction value according to the initial signal-noise characteristic value, and generating a corrected signal-noise characteristic value according to the corresponding correction value and the initial signal-noise characteristic value.

2. The receiver circuit according to claim 1, wherein the correction circuit comprises:
a look-up table (LUT) circuit, storing a plurality of predetermined correction values, providing the corresponding correction value according to the initial signal-noise characteristic value and the predetermined correction values, wherein each of the predetermined correction values corresponds to one of a plurality of predetermined signal-noise characteristic values; and
a multiplier, coupled to the LUT circuit and the estimation circuit, multiplying the initial signal-noise characteristic value by the corresponding correction value to generate the corrected signal-noise characteristic value.

3. The receiver circuit according to claim 2, wherein the LUT circuit provides the corresponding correction value by identifying one predetermined correction value corresponding to a predetermined signal-noise characteristic value that is closest to the initial signal-noise characteristic value from the predetermined correction values.

4. The receiver circuit according to claim 2, wherein, with the predetermined signal-noise characteristic values arranged in an increasing order, changes of at least a partial number of the corresponding predetermined correction values first display a first increasing/decreasing trend and then display a second increasing/decreasing trend, and the first increasing/decreasing trend and the second increasing/decreasing trend are opposite.

5. The receiver circuit according to claim 4, wherein the first increasing/decreasing trend is strictly decreasing, and the second increasing/decreasing trend is strictly increasing.

6. The receiver circuit according to claim 1, wherein the correction circuit provides the corresponding correction value further according to a modulation setting of the received signal.

7. The receiver circuit according to claim 2, wherein the LUT circuit provides the corresponding correction value further according to a modulation setting of the received signal; each of the predetermined correction values corresponds to one of a plurality of predetermined signal-noise characteristic values; for the plurality of predetermined correction values corresponding to the same predetermined signal-noise characteristic value but corresponding to different predetermined modulation settings, with bit counts the predetermined modulation settings carry within one unit time arranged in an increasing order, changes of at least a partial number of the predetermined correction values display a decreasing trend.

8. The receiver circuit according to claim 6, further comprising:
a bit loading setting circuit, coupled to the correction circuit, generating a feedback signal to a transmitter circuit according to the corrected signal-noise characteristic value to update the modulation setting of the received signal.

9. A method for correcting a signal-noise characteristic value in a receiver circuit, comprising:
providing an equalized signal according to a received signal the receiver circuit receives;
providing a sliced signal according to the equalized signal;
providing an initial signal-noise characteristic value according a difference between to the equalized signal and the sliced signal;
providing a corresponding correction value according to the initial signal-noise characteristic value; and
generating a corrected signal-noise characteristic value according to the corresponding correction value and the initial signal-noise characteristic value.

10. The method according to claim 9, wherein the step of providing the corresponding correction value according to the initial signal-noise characteristic value further comprises:
providing the corresponding correction value according to the initial signal-noise characteristic value and a plurality of predetermined correction values, wherein each of the predetermined correction values corresponds to one of a plurality of predetermined signal-noise characteristic values.

11. The method according to claim 10, wherein the step of providing the corresponding correction value according to the initial signal-noise characteristic value and the predetermined correction values further comprises:
identifying one predetermined correction value corresponding to a predetermined signal-noise characteristic value that is closest to the initial signal-noise characteristic value from the predetermined correction values to provide the corresponding correction value.

12. The method according to claim 10, wherein, with the predetermined signal-noise characteristic values arranged in an increasing order, changes of at least a partial number of the corresponding predetermined correction values first display a first increasing/decreasing trend and then display a second increasing/decreasing trend, and the first increasing/decreasing trend and the second increasing/decreasing trend are opposite.

13. The method according to claim 12, wherein the first increasing/decreasing trend is strictly decreasing, and the second increasing/decreasing trend is strictly increasing.

14. The method according to claim 10, wherein the step of providing the corresponding correction value according to the initial signal-noise characteristic value and the plurality of predetermined correction values further comprises:
providing the corresponding correction value further according to a modulation setting of the received signal.

15. The method according to claim 14, wherein each of the predetermined correction values corresponds to one of a plurality of predetermined signal-noise characteristic values; for the plurality of predetermined correction values corresponding to the same predetermined signal-noise characteristic value but corresponding to different predetermined modulation settings, with bit counts the predetermined modulation settings carry within one unit time arranged in an increasing order, changes of at least a partial number of the predetermined correction values display a decreasing trend.
